(19) United States
(12) Patent Application Publication
(10) Pub. No.: US 2012/0010942 A1
(43) Pub. Date: Jan. 12, 2012

(54) ONLINE ADVERTISING MARKETPLACE DATA PROVIDER ASSESSMENT AND RECOMMENDATION

(75) Inventors: Eric Theodore Bax, Altadena, CA (US); Tarun Bhatia, Simi Valley, CA (US); Ayman Farahat, San Francisco, CA (US)

(73) Assignee: Yahoo! Inc., Sunnyvale, CA (US)

(21) Appl. No.: 12/831,897

(22) Filed: Jul. 7, 2010

(51) Int. Cl. G06Q 30/00

(52) U.S. Cl. 705/14.41

(57) ABSTRACT

The present invention provides techniques for use in assessing the value of information-related services of particular data providers to an online advertising marketplace participant, such as an advertiser, publisher, market-maker, or another data provider, in connection with activities relating to buying, selling or pricing of marketplace properties. Furthermore, a recommendation may be provided to the marketplace participant as to the value or desirability of the services of particular data providers. Techniques are provided in which actual or hypothetical impact of use of information of the particular data providers is assessed.

### BACKGROUND

In online advertising markets, as in other markets, information can improve decision-making, efficiency and return on investment. Often, online advertising exchange or marketplace participants pay for and use the services of data providers. For example, advertisers (which can include advertiser agents or proxies, such as networks, etc.) use data provider information in optimizing determinations and decision-making relating to advertisement inventory purchasing, such as in selecting which advertisement calls to purchase and how much to bid or pay for them, where an advertisement call is or can be an opportunity to advertise.

Generally, marketplace participants, such as advertisers, can benefit from choosing a data provider or set of data providers, and obtaining data provider information, that best helps them optimize their marketplace activities. As more data providers and inventory sources become available, however, this can be very challenging. Yet, lack of exploration of and knowledge regarding data providers and data provider information can lead to, for example, inefficient advertising campaigns, less return on investment, and consequent lessening of participation in the marketplace that negatively affects all marketplace participants, ctc.

There is a need for techniques for use in assessing, and providing information or recommendations to marketplace participants regarding, data providers in connection with online advertising markets.

### SUMMARY

Some embodiments of the invention provide techniques for use in assessing the value of information-related services of particular data providers to an online advertising marketplace participant, such as an advertiser, publisher, market-maker, or another data provider, in connection activities relating to buying, selling or pricing of marketplace properties. Furthermore, in some embodiments, a recommendation may be provided to the marketplace participant as to the value or desirability of the services of particular data providers. In some embodiments, hypothetical or actual impact of use of information of the particular data providers is assessed, which may include, for example, use of passive techniques or controlled experimentation.

### BRIEF DESCRIPTION OF THE DRAWINGS

FIG. 1 is a distributed computer system according to one embodiment of the invention;

FIG. 2 is a block diagram illustrating one embodiment of the invention;

FIG. 3 is a flow diagram illustrating a method according to one embodiment of the invention;

FIG. 4 is a flow diagram illustrating a method according to one embodiment of the invention;

FIG. 5 is a flow diagram illustrating a method according to one embodiment of the invention; and

FIG. 6 is a flow diagram illustrating a method according to one embodiment of the invention.

While the invention is described with reference to the above drawings, the drawings are intended to be illustrative, and the invention contemplates other embodiments within the spirit of the invention.

### DETAILED DESCRIPTION

Herein, the term “properties” is intended to be broadly defined and include, for instance, anything that can be bought or sold through the marketplace. Furthermore, the term “marketplace” is intended to be broadly defined and can include markets or exchanges, including virtual markets or exchanges.

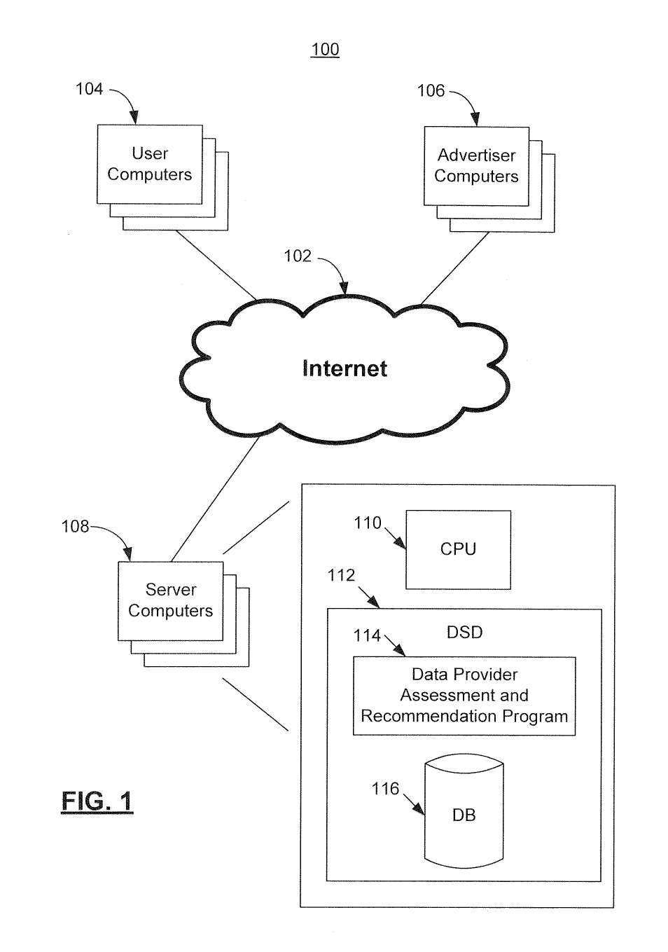

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and A Data Provider Assessment and Recommendation Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

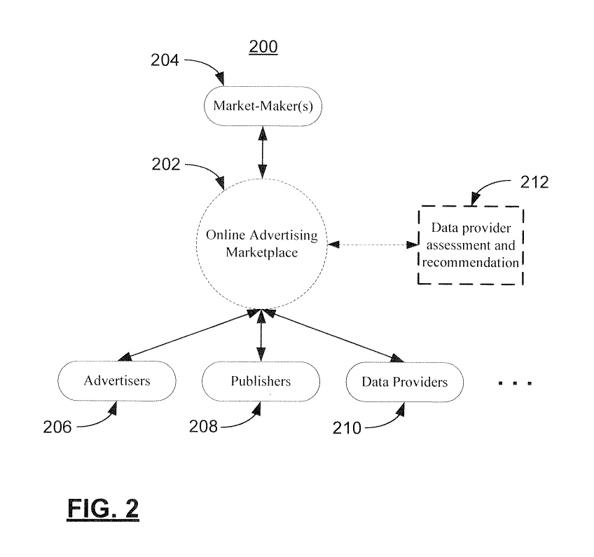

FIG. 2 is a block diagram 200 illustrating one embodiment of the invention. Depicted are a conceptually represented online advertising marketplace 202, advertisers 206, publishers 208, data providers 210, and one or more market-makers 204 (which can be any marketplace facilitator or can be or include the marketplace 202 itself or elements thereof). Also conceptually depicted is data provider assessment and recommendation 212 according to embodiments of the invention as described herein.

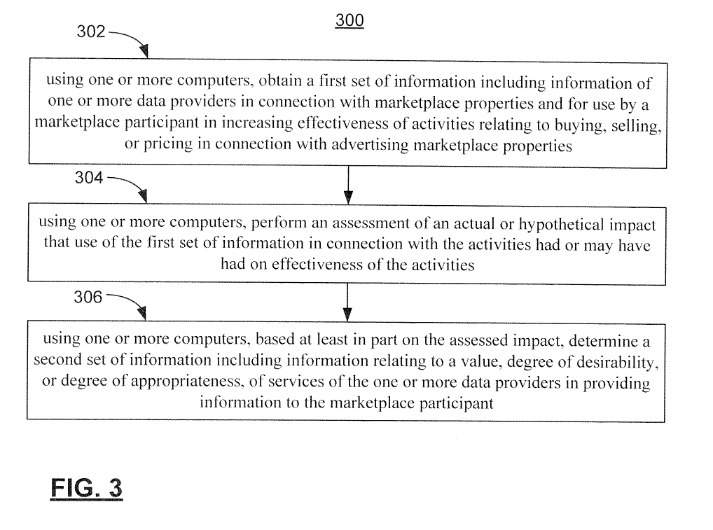

FIG. 3 is a flow diagram illustrating a method 300 according to one embodiment of the invention. At step 302, using one or more computers, a first set of information is obtained, including information of one or more data providers in connection with marketplace properties and for use by a marketplace participant in increasing effectiveness of activities relating to buying, selling, or pricing in connection with advertising marketplace properties.

At step 304, using one or more computers, an assessment is performed of an actual or hypothetical impact that use of the first set of information in connection with the activities had or may have had on effectiveness of the activities.

At step 306, using one or more computers, based at least on the assessed impact, a second set of information is determined, including information relating to a value, degree of desirability, or degree of appropriateness, of services of the one or more data providers in providing information to the marketplace participant.

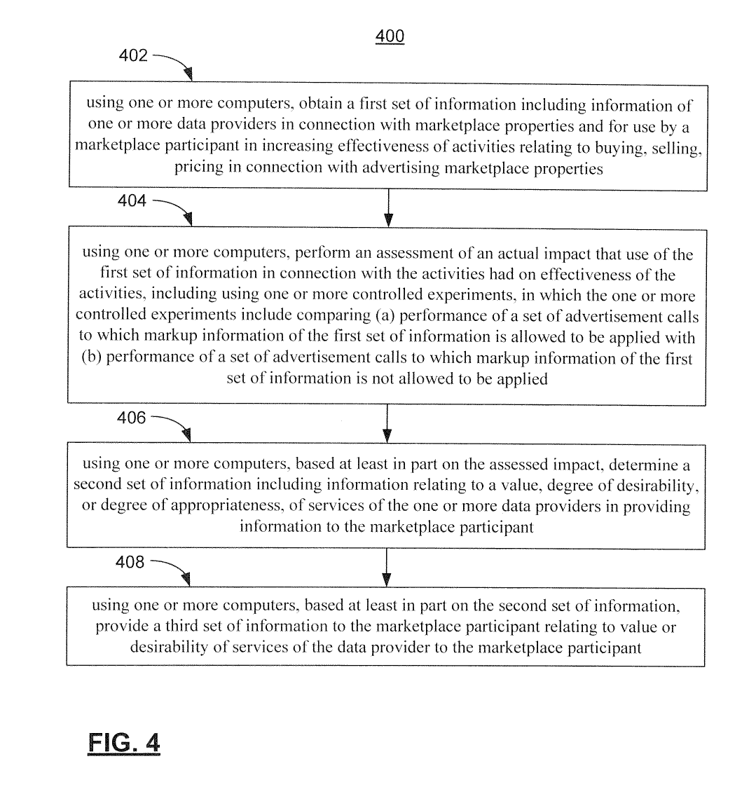

FIG. 4 is a flow diagram illustrating a method 400 according to one embodiment of the invention. Step 402 is similar to step 302 of the method 300 depicted in FIG. 3.

At step 404, using one or more computers, an assessment is performed of an actual impact that use of the first set of information in connection with the activities had on effectiveness of the activities, including using one or more controlled experiments, in which the one or more controlled experiments include comparing (a) performance of a set of advertisement calls to which markup information of the first set of information is allowed to be applied with (b) performance of a set of advertisement calls to which markup information of the first set of information is not allowed to be applied.

At step 406, using one or more computers, based at least on the assessed impact, a second set of information is determined, including information relating to a value, degree of desirability, or degree of appropriateness, of services of the one or more data providers in providing information to the marketplace participant.

At step 408, using one or more computers, based at least in part on the second set of information, a third set of information is provided to the marketplace participant relating to value or desirability of services of the data provider to the marketplace participant.

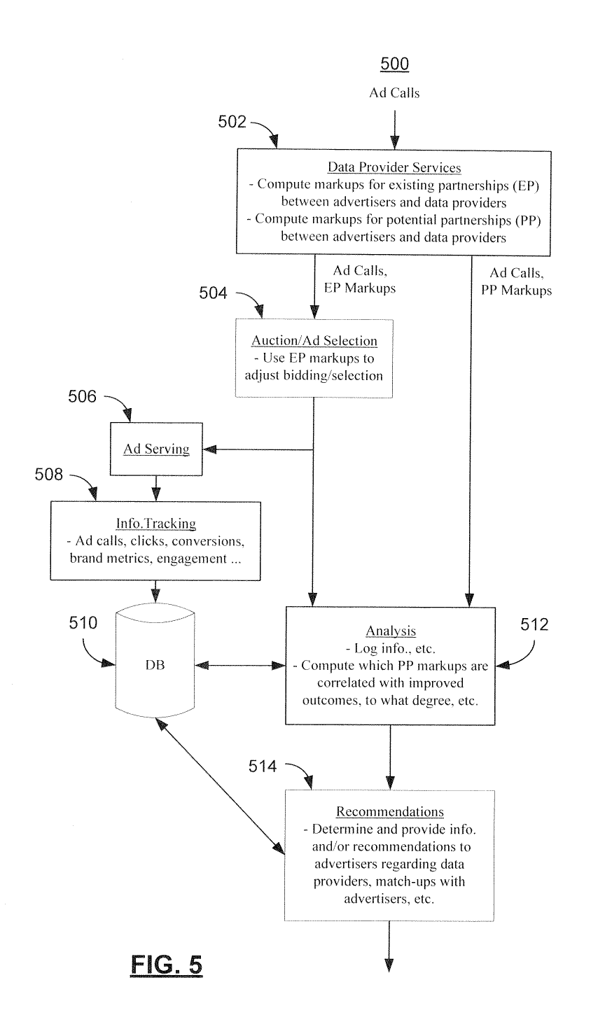

FIG. 5 is a flow diagram illustrating a method 500 according to one embodiment of the invention. In some ways, the method 500 can be considered a passive method in assessing data providers and their services, in that data provider markups are not actually applied to bidding and selection, but instead, the effect that such markups would or may have had is analyzed and assessed.

At step 502, data provider services are utilized in connection with advertisement calls. In particular, data provider markups are computed for existing partnerships between advertisers and data providers, and data provider markups are computed for potential partnerships between advertisers and data providers.

At step 504, information is passed to a marketplace auction and advertisement selection process, at which existing partnership markups are used to adjust bidding and selection.

Step 506 represents advertisement serving, in accordance with activities at step 504.

At step 508, tracking of information is performed, which can include downstream tracking. For example, tracked information can include advertisement calls, clicks, conversions, brand metrics, engagement metrics (which can be metrics to measure positive user brand engagement, for instance), and other information.

Tracked information is stored in one or more data stores or databases 510.

Step 512 represents analysis of information passed in connection with steps 504 to 510, including information relating to activities in connection with existing partnership markups, as well as including information in connection with potential partnership markups which were not actually applied. The analysis can include assessing the actual effectiveness of existing partnership markups and the hypothetical effectiveness of the potential partnership markups, had they been applied. The two can be compared to assess value or desirability of potential partnerships, and of potential data providers and their services.

Analysis at step 512 can include, for example, logging advertisement calls, clicks, brand metrics, engagement metrics, existing partnership markups, potential partnership markups, and winning offers. The analysis can also include computing which potential partnership markups are correlated with improved outcomes, desirability, appropriateness, or effectiveness, such as improved metrics relating to clicks, conversions, branding, engagement, etc.

At step 514, information determined at step 512 is utilized in determining and providing recommendations for advertisers relating to potential data providers or partnerships.

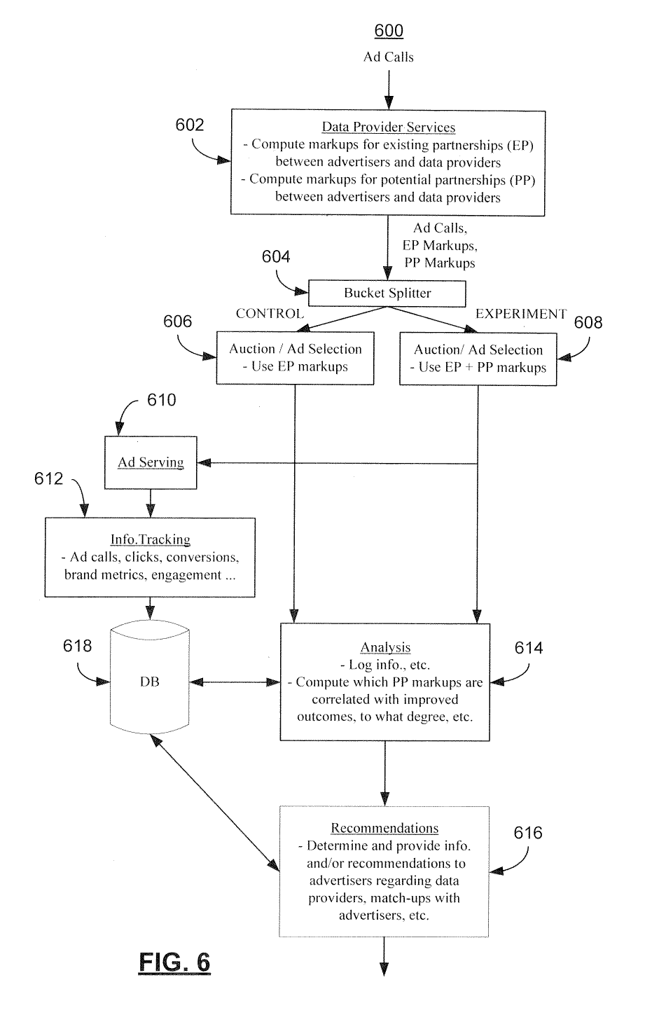

FIG. 6 is a flow diagram illustrating a method 600 according to one embodiment of the invention. In some ways, the method 600 can be viewed as an active method to assess data providers, since data provider markups are actually applied. The method 600 includes use of controlled experimentation.

Step 602 is similar to step 502 of the method 500 depicted in FIG. 5.

Step 604 represents input of information relating to advertisement calls, existing partnership markups, and potential partnership markups to a bucket splitter, as used in bucket testing experimentation.

Step 06 represents auction and advertisement selection activities in connection with control testing activities, including use of only existing partnership markups.

Step 608 represents auction and advertisement selection activities in connection with experimental testing activities, including use of existing partnership markups and potential partnership markups.

Steps 610 and 612 include advertisement serving and tracking of information, and storage in one or more databases 618, in a manner similar to steps 506 and 508 of the method 500 depicted in FIG. 5. However, both the control testing activities element, including use of only existing partnership markups, and the experimental testing activities element, including use of existing partnership markups and potential partnership markups, are actively passed on for advertisement serving, separate tracking, etc.

Steps 614 and 616 are similar to steps 512 and 514 of the method 500 depicted in FIG. 5. However, actual effectiveness of particular existing partnerships, as from the control testing activities, and actual effectiveness of particular potential partnerships, as from the experimental testing activities element, are assessed and compared. Information and recommendations are then determined and provided to advertisers relating to data providers or partnerships.

Generally, the online marketplace applies services from data providers with existing partnerships with participants to mark up inventory so that participants with existing partnerships with the data providers can use the markups in their bidding, packaging, or advertisement selection, for example. In some embodiments of the invention, the online marketplace applies services from potential partner data providers to produce potential markups (in addition to existing partner markups) for inventory in the marketplace. The potential markups are logged and their potential effectiveness is evaluated or assessed, for example, using statistical methods. In some embodiments, when the evaluation indicates that a participant would benefit from the services of a data provider, the participant and/or data provider are informed, and/or provided with a recommendation, so that they can, for example, consider or make arrangements to partner.

In some embodiments of the invention, data providers are evaluated to estimate the value they offer to advertisers. The estimates may be used to recommend data providers for advertisers, who can then make arrangements to use services from the recommended data providers. As a result, for example, advertisers increase return on investment, the most effective data providers increase their business, and publishers benefit from increased prices on their most valuable advertisement calls and increased buying from advertisers.

In addition to serving advertisers, data providers may also serve publishers by informing their packaging and pricing policies. For example, data providers may supply data on users. That data enables publishers to package sets of advertisement calls by user characteristics, such as, for example, “advertisement calls on pages served to soccer moms.” In addition to data on users, data providers may supply data on content, enabling packages that focus on events such as sporting events or holidays. Packaging can enable publishers to charge higher prices. Packaging can also allow publishers to make larger sales by combining their packaged inventory with inventory from other publishers that have the same or similar user characteristics. These co-selling arrangements allow sellers to offer greater reach and frequency to buyers. Some embodiments of the invention evaluate data providers for the value they offer publishers and recommend data providers and publishers to each other.

Data providers may also serve market-makers, which can include marketplace facilitators. The provided data can enable more accurate prediction of response rates for different advertisements on different advertisement calls. Better response prediction enables the market-maker to increase return on investment for buyers while increasing revenue for sellers. So a market-maker can increase participation from buyers and sellers and hence increase its business. Some embodiments of the invention evaluate data providers for the value they offer market-makers and recommend data providers and market-makers to each other.

Data providers may serve one another. Some combinations of data providers may offer more value together than alone. For example, one data provider may recognize credit-worthy users and another may recognize users who are interested in purchasing new cars. Some embodiments of the invention evaluate data providers for the value they offer each other.

Some embodiments of the invention may use different methods to evaluate how effectively different data providers would serve different advertisers, including more passive methods and more active methods, for example.

More passive methods can include, for example, the method 500 depicted in FIG. 5. Some embodiments, for example, include the following. For advertisement calls purchased by the advertiser, the data provider's methods are applied to determine which advertisement calls would have received which data mark-ups (e.g. “soccer mom”, “online music buyer”, . . . ) from the data provider. Tracking is then performed of the price and value of advertisement calls for each mark-up. This is then compared to the price and value for the whole set of advertisement calls purchased by the advertiser to determine which mark-ups indicate increased return on investment and how much.

More active methods can include, for example, the method 600 depicted in FIG. 6. Some embodiments, for example, include the following. Controlled tests are run, applying the data provider's methods to determine mark-ups and using those mark-ups as part of buying decisions for some advertisement calls (the experimental advertisement calls) and not for others (the control group of advertisement calls). If the tests show an increase in return on investment when the mark-ups are used in the buying/bidding process, then a recommendation is made, recommending the data provider to the advertiser.

Some embodiments include use of a recommender system or collaborative filtering. Some embodiments, for example, include recommending data providers that perform on some advertisers to similar advertisers.

Some embodiments include use of a classification, regression, modeling, or machine learning method. This can include developing a mapping from characteristics of data providers and advertisers to how much value the data providers add for each advertiser, based on known results for some data provider-advertiser pairs. That mapping can then be used to estimate the value for untested data provider-advertiser pairs, for example.

Advertisers may have other goals than return on investment, such as reach or reach at frequency. In some embodiments, data providers may be evaluated for these goals as well. Furthermore, some embodiments include a recognition that advertisers may determine value based on response rate of clicks or conversions, based on surveys for brand recognition or sentiment toward the brand, or through other means, such as volume of in-store sales caused by showing the advertisement, for example.

Some embodiments include a recognition that different services from different data providers may have different costs. In some embodiments, evaluation of a match between a data provider and an advertiser may include cost of data provider services as a factor.

In some embodiments, methods similar to those for advertisers may be used to discover which data providers can offer the greatest value to publishers (which can include publisher agents or proxies). For example, in some embodiments, for advertisement calls sold by the publisher, the data provider's methods may be applied to determine which advertisement calls would have received high mark-ups. Price and performance can be tracked for each mark-up. Marked-up performance can be compared to baseline performance to estimate added value.

In some embodiments, a recommender system is utilized. For example, data providers can be recommended that perform well for some publishers to similar publishers.

In some embodiments, a classification, regression, or modeling method may be used. This can include, for example, developing a mapping from characteristics of data providers and publishers to how much value the data providers add for each publisher, based on known results for some data provider-publisher pairs. That mapping can then be used to estimate the value for untested data provider-publisher pairs.

In some embodiments, to determine potential value from using a data provider to form packages, data providers methods may be applied to determine which advertisement calls would have received mark-ups and which advertisement calls would have joined which packages as a result. To estimate the value of using mark-ups to contribute additional advertisement calls to existing packages, some embodiments include use of sales figures for those packages or demand for them expressed by current and potential buyers. To estimate the value of forming new packages based on the mark-ups, some embodiments include use of sales figures for similar packages, sales estimates for other sellers of the new packages, and demand expressed by buyers and potential buyers.

Some embodiments include a recognition that publishers may use data providers to set reserve prices as well as for packaging. Similar methods to those described above can be used in such instances.

In some embodiments, methods similar to those for advertisers and publishers may be used to evaluate which data providers can offer the best value for market-makers.

Some embodiments include use of controlled experiments, applying a data provider's methods to some advertisement calls and using the mark-ups to perform matching for those advertisement calls (the experimental group of advertisement calls). The mark-ups are not used in performing matching for a control group of advertisement calls. Results are then compared for experimental and control groups to evaluate the data provider.

Some embodiments include use of a classification, regression, or modeling method, which can include developing a mapping from data provider characteristics to value added for advertisement-to-advertisement call matching. The mapping can then be used to evaluate data providers.

In some embodiments, methods similar to those for other participants may be used to evaluate which data providers can offer the best value for other data providers. For example, a more passive method can be used, including recording which co-markups would be made between prospective partner data providers and analyzing value added by using combined markups. In some embodiments, a more active method can be used, including experimenting with co-markups and comparing to controls that do not use the co-markups. In some embodiments, classification, regression, or modeling is used to evaluate complementary value for co-markups and/or similarity of markups. Combining similar markups can allow combinations of data providers to offer wider reach and more frequency for those markups. Furthermore, in some embodiments, a recommender system can be used to identify complementary and similar markups based on successful existing partnerships among data providers and outcomes for other participants.

In some embodiments, experiments are used that are based on combinatorial designs to evaluate the benefits of using multiple data providers and different combinations of data providers.

In some embodiments, evaluations or assessments of value are used in determining payments to data providers, with the market-maker matching advertisement-to-advertisement call-to-data rather than just advertisement-to-advertisement call.

While the invention is described with reference to the above drawings, the drawings are intended to be illustrative, and the invention contemplates other embodiments within the spirit of the invention.

1. A method for use in association with an online advertising marketplace, comprising:
using one or more computers, obtaining a first set of information comprising information of one or more data providers in connection with marketplace properties and for use by a marketplace participant in increasing effectiveness of activities relating to buying, selling, or pricing in connection with advertising marketplace properties;
using one or more computers, performing an assessment of an actual or hypothetical impact that use of the first set of information in connection with the activities had or may have had on effectiveness of the activities; and
using one or more computers, based at least in part on the assessed impact, determining a second set of information comprising information relating to a value, degree of desirability, or degree of appropriateness, of services of the one or more data providers in providing information to the marketplace participant.

2. The method of claim 1, wherein the one or more data providers provide markup information relating to marketplace properties.

3. The method of claim 1, wherein the one or more data providers provide markup information relating to marketplace properties, and wherein the marketplace is an auction-based marketplace including advertising bidding.

4. The method of claim 1, wherein the one or more data providers provide markup information relating to marketplace properties, and wherein the marketplace properties comprise advertising or publishing inventory.

5. The method of claim 1, comprising providing information of the second set of information for use by the marketplace participant, and wherein in the marketplace participant is an advertiser.

6. The method of claim 1, comprising providing information of the second set of information for use by the marketplace participant, and wherein the marketplace participant is a publisher.

7. The method of claim 1, comprising providing information of the second set of information for use by the marketplace participant, and wherein the marketplace participant is a market-maker or a marketplace facilitator.

8. The method of claim 1, comprising providing information of the second set of information for use by a marketplace participant, and wherein the marketplace participant is a data provider.

9. The method of claim 1, wherein performing the assessment comprises performing an assessment of a hypothetical impact that use of the first set of information may have had.

10. The method of claim 1, wherein performing the assessment comprises performing an assessment of a hypothetical impact that use of the first set of information may have had, comprising comparing (a) hypothetical performance of a set of advertisement calls that would have been affected by markups of the first set of information with (b) actual performance of a set of advertisement calls including the advertisement calls that would have been affected by markups of the first set of information and advertisement calls that would not have been affected by markups of the first set of information.

11. The method of claim 1, wherein performing the assessment comprises performing an assessment of an actual impact of use of the first set of information, comprising using one or more controlled experiments.

12. The method of claim 1, wherein performing the assessment comprises performing an assessment of an actual impact of use of the first set of information, comprising using one or more controlled experiments, wherein the one or more controlled experiments include comparing (a) performance of a set of advertisement calls to which markup information of the first set of information is allowed to be applied with (b) performance of a set of advertisement calls to which markup information of the first set of information is not allowed to be applied.

13. The method of claim 1, comprising using the second set of information in providing information to the marketplace participant relating to value or desirability of services of the one or more data providers to the marketplace participant.

14. The method of claim 1, comprising utilizing the second set of information in providing a recommendation to the marketplace participant relating to whether the marketplace participant should use or should consider using services of the data provider.

15. The method of claim 1, wherein assessing data providers includes use of one or more machine learning, classification, or regression-based techniques.

16. The method of claim 1, wherein assessing data providers includes use of one or more recommender system techniques or collaborative filtering techniques.

17. A system for use in association with an online advertising marketplace, comprising:
one or more server computers coupled to a network; and
one or more databases coupled to the one or more server computers;
wherein the one or more server computers are for:
obtaining, and storing in at least one of the one or more databases, a first set of information comprising information of one or more data providers in connection with marketplace properties and for use by a marketplace participant in increasing effectiveness of activities relating to buying, selling, or pricing in connection with advertising marketplace properties;
performing an assessment of an actual or hypothetical impact that use of the first set of information in connection with the activities had or may have had on effectiveness of the activities; and
based a least in part on the assessed impact, determining a second set of information comprising information relating to a value, degree of desirability, or degree of appropriateness, of services of the one or more data providers in providing information to the marketplace participant.

18. The system of claim 17, comprising utilizing the second set of information in providing a recommendation to the marketplace participant relating to value or desirability of services of the data provider to the marketplace participant.

19. The system of claim 17, wherein performing the assessment comprises performing an assessment of an actual impact of use of the first set of information, comprising using one or more controlled experiments, wherein the one or more controlled experiments include comparing (a) performance of a set of advertisement calls to which markup information of the first set of information is allowed to be applied with (b) performance of a set of advertisement calls to which markup information of the first set of information is not allowed to be applied.

20. A computer readable medium or media containing instructions for executing a method for use in association with an online advertising marketplace comprising:
using one or more computers, obtaining a first set of information comprising information of one or more data providers in connection with marketplace properties and for use by a marketplace participant in increasing effectiveness of activities relating to buying, selling, or pricing in connection with advertising marketplace properties;
using one or more computers, performing an assessment of an actual impact that use of the first set of information in connection with the activities had on effectiveness of the activities, comprising using one or more controlled experiments, wherein the one or more controlled experiments include comparing (a) performance of a set of advertisement calls to which markup information of the first set of information is allowed to be applied with (b) performance of a set of advertisement calls to which markup information of the first set of information is not allowed to be applied;
using one or more computers, based at least in part on the assessed impact, determining a second set of information comprising information relating to a value, degree of desirability, or degree of appropriateness, of services of the one or more data providers in providing information to the marketplace participant; and
using one or more computers, based at least in part on the second set of information, providing a third set of information to the marketplace participant relating to value or desirability of services of the data provider to the marketplace participant.
